(19) United States
(12) Patent Application Publication
(10) Pub. No.: US 2024/0228086 A1
(43) Pub. Date: Jul. 11, 2024

(54) DRUG SUPPLY APPARATUS

(71) Applicant: PHC Holdings Corporation, Tokyo (JP)

(72) Inventors: Syou OUMI, Ehime (JP); Shiyouji SHIBATA, Ehime (JP); Toshiaki UETA, Tokushima (JP)

(21) Appl. No.: 18/615,822

(22) Filed: Mar. 25, 2024

Related U.S. Application Data
(63) Continuation of application No. PCT/JP2022/035521, filed on Sep. 22, 2022.

(30) Foreign Application Priority Data
Sep. 29, 2021 (JP) 2021-159495

(51) Int. Cl. B65B 9/087; A61J 3/00; B65B 9/02; B65B 41/16; B65B 51/16

(52) U.S. Cl. CPC B65B 9/087; A61J 3/00; B65B 9/02; B65B 41/16; B65B 51/16

(57) ABSTRACT

A drug supply apparatus of the present disclosure includes a drug supply unit configured to supply a drug to a drug delivery position; a downstream conveying unit configured to convey a strip-shaped first drug packaging paper, folded in half in advance along its longitudinal direction and configured to receive a drug at the drug delivery position; and an upstream conveying unit configured to convey a strip-shaped second drug packaging paper, folded in half in advance along its longitudinal direction. In the apparatus, the upstream conveying unit conveys the second drug packaging paper toward the first drug packaging paper in such a way that the downstream end part of the second drug packaging paper holds in its inside the upstream end part of the first drug packaging paper, and the ridge line of the second drug packaging paper overlaps the ridge line of the first drug packaging paper.

### CROSS-REFERENCE OF RELATED APPLICATIONS

This is a Continuation of International Application No. PCT/JP2022/035521, filed on Sep. 22, 2022, which claims priority to Japanese Patent Application No. 2021-159495, filed on Sep. 29, 2021, the entire disclosures each of which are hereby incorporated by reference.

### TECHNICAL FIELD

The present disclosure relates to a drug supply apparatus.

### BACKGROUND ART

Patent Literature (hereinafter, referred to as PTL) 1 discloses a packaging paper connecting apparatus that connects the terminal end of packaging paper, which has been folded in half in advance along the longitudinal direction thereof and is used to package a drug, to the starting end of new packaging paper. An operator manually overlaps the terminal end of the packaging paper to be replaced and the starting end of the new packaging paper, and places the overlapped portions at a predetermined position. As the operator connects the overlapped portions to each other, the terminal end of the packaging paper to be replaced and the starting end of the new packaging paper are connected.

### CITATION LIST

### Patent Literature

PTL 1
Japanese Patent No. 5577526

### SUMMARY OF INVENTION

### Technical Problem

In the packaging paper connecting apparatus of PTL 1, an operator manually replaces packaging paper. On the other hand, automation of packaging paper replacement is being promoted for the purpose of increasing the efficiency of the work for the packaging paper replacement. During the replacement of packaging paper, when new packaging paper is automatically conveyed, the leading edge of new packaging paper may be caught by a guide that guides the new packaging paper, for example. In such a case, folds are generated in the new packaging paper, and thus the new packaging paper cannot be smoothly conveyed.

An object of the present disclosure is to smoothly convey packaging paper during the replacement of packaging paper in a drug supply apparatus.

### Solution to Problem

A drug supply apparatus of the present disclosure includes the following: a drug supply unit configured to supply a drug to a drug delivery position; a downstream conveying unit configured to convey a first drug packaging paper that is strip shaped and folded in half in advance along a longitudinal direction of the first drug packaging paper, in which the first drug packaging paper is configured to receive a drug at the drug delivery position; and an upstream conveying unit configured to convey a second drug packaging paper that is strip shaped and folded in half in advance along a longitudinal direction of the second drug packaging paper, in which the upstream conveying unit conveys the second drug packaging paper toward the first drug packaging paper in such a way that a downstream end part of the second drug packaging paper holds, in an inside of the downstream end part, an upstream end part of the first drug packaging paper, and a ridge line of the second drug packaging paper overlaps a ridge line of the first drug packaging paper.

### Advantageous Effects of Invention

A drug supply apparatus of the present disclosure is capable of smoothly conveying packaging paper during the replacement of packaging paper.

### BRIEF DESCRIPTION OF DRAWING

FIG. 1 is a perspective view of a drug supply apparatus according to an embodiment of the present disclosure;

FIG. 2 is a longitudinal cross-sectional view of the drug supply apparatus;

FIG. 3 schematically illustrates a portion of a conveying part;

FIG. 4 is a partially enlarged view of FIG. 3;

FIG. 5 illustrates the side and a periphery of first drug packaging paper in FIG. 4;

FIG. 6 illustrates a state in which the first drug packaging paper has been cut;

FIG. 7 illustrates a state immediately before second drug packaging paper is conveyed;

FIG. 8 illustrates the side and a periphery of the first drug packaging paper in FIG. 7;

FIG. 9 is a longitudinal cross-sectional view of a guide member and a periphery thereof;

FIG. 10 illustrates a state in which the second drug packaging paper is conveyed and overlaps the first drug packaging paper;

FIG. 11 illustrates a variation of a pair of rollers; and

FIG. 12 illustrates a variation of the pair of rollers.

### DESCRIPTION OF EMBODIMENTS

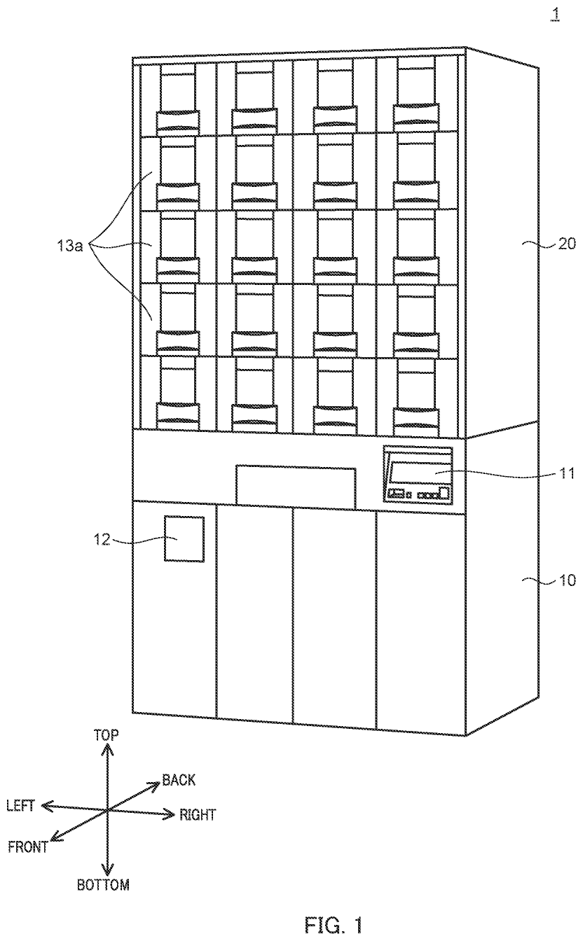

Hereinafter, at least one embodiment of the drug supply apparatus of the present disclosure will be described with reference to the drawings. In the following description, the side where operation part 11 is disposed is referred to as the front of drug supply apparatus 1, and the opposite side is referred to as the back of drug supply apparatus 1 as indicated by the arrows in FIG. 1. In addition, the left and right sides of drug supply apparatus 1 when viewed from the front thereof are referred to as the left and right of drug supply apparatus 1, respectively. The side away from the surface on which drug supply apparatus 1 is installed is referred to as the top of drug supply apparatus 1 (upward or above the apparatus), and the opposite side is referred to as the bottom of drug supply apparatus 1 (downward or below the apparatus).

FIG. 1 is a perspective view of exemplary drug supply apparatus 1. Drug supply apparatus 1 includes first floor part 10 and second floor part 20.

First floor part 10 includes operation part 11 and take-out part 12. In addition, first floor part 10 includes an input part (not illustrated).

Operation part 11 is a device to be operated by an operator, and includes, for example, a display, operation buttons, and the like. Various information is input to drug supply apparatus 1 as the operator operates operation part 11.

A drug (herein, a drug may be more than one drug) packaged in drug supply apparatus 1 is taken out from take-out part 12. Take-out part 12 includes an opening, and the operator takes out the drug from the opening.

The input part is an input device receiving various information input from an external device. The input part is connected to, for example, a personal computer, and receives input from the personal computer, for example, information on a prescription issued at a medical institution.

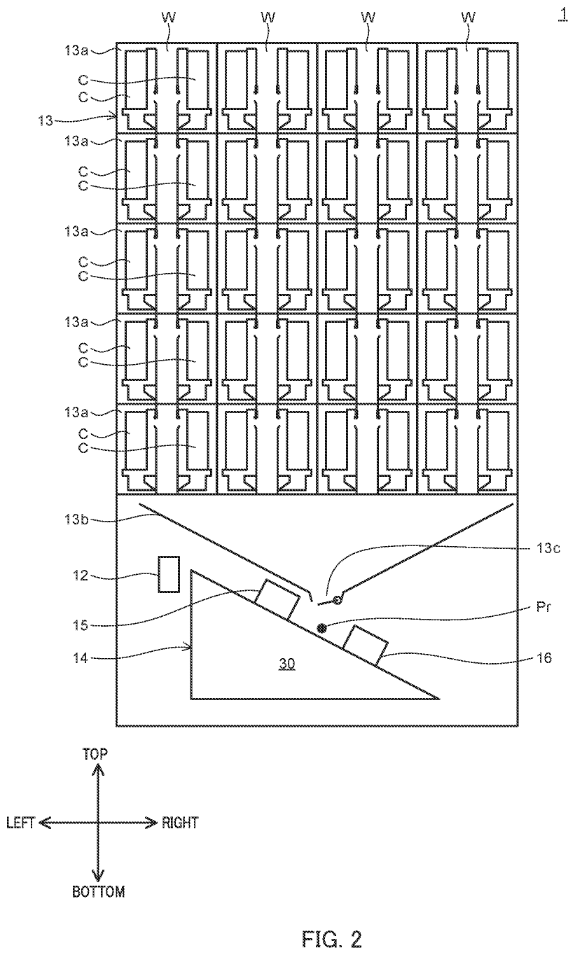

As illustrated in FIG. 2, drug supply apparatus 1 includes drug supply unit 13, packaging unit 14, and control part (not illustrated) which performs overall control of drug supply apparatus 1. Drug supply unit 13 is configured to supply a drug to drug delivery position Pr. Drug supply unit 13 includes a plurality of shelves 13a and hopper 13b.

The plurality of shelves 13a are each configured to store the plurality of cassettes C in the second floor part. Drug supply apparatus 1 includes 20 shelves 13a. The plurality of shelves 13a are arranged in five stages in the up-down direction and in four rows in the left-right direction. The number and arrangement of shelves 13a provided in second floor part 20 are not limited to those of the present embodiment, and the number of stages in the up-down direction and/or the number of rows in the left-right direction may be more or less than those described above.

A plurality of cassettes C are stored in each shelf 13a so as to be arranged on shelf 13a along the front and rear direction on both sides of shelf 13a in the left-right direction. Each cassette C stores a plurality of drugs. Each cassette C is configured to discharge one tablet of a drug at a time.

The drug discharged from cassette C falls through passage W and is led to first floor part 10. Passage W is provided so as to penetrate each shelf 13a in the up-down direction.

Hopper 13b is configured to receive the drug led to first floor part 10, and lead the received drug through outlet 13c to drug delivery position Pr in packaging unit 14. Outlet 13c is provided approximately at the center of hopper 13b.

Packaging unit 14 is configured to package the drug led out from hopper 13b. Packaging unit 14 includes conveying part 30, printer 15, and sealing device 16.

Conveying part 30 is configured to convey strip-shaped packaging paper for packaging a drug. Details of conveying part 30 will be described below.

Printer 15 is a printing machine for printing, for example, the patient's name, the name of the drug to be supplied in packaging paper conveyed by conveying part 30, the date and time of administration, and the like on the surface of the packaging paper.

Sealing device 16 is for sealing the packaging paper in which a drug is wrapped.

The packaging paper in which the drug is enclosed is cut, for example, with predetermined timing and is conveyed toward take-out part 12 with the conveyance direction thereof changed by conveying part 30.

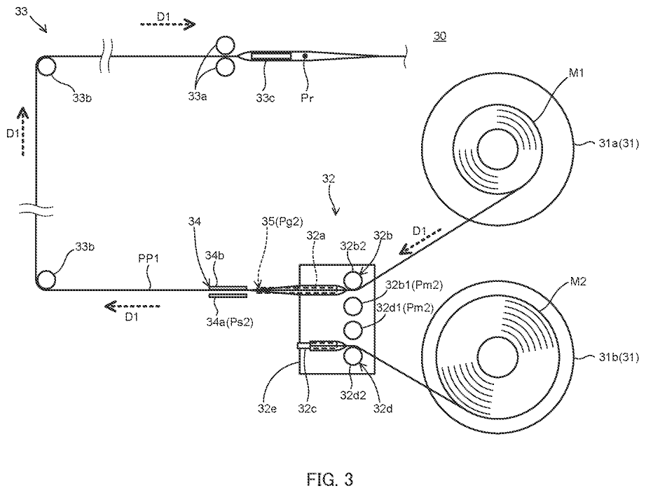

In the following, conveying part 30 will be described. As illustrated in FIG. 3, conveying part 30 includes packaging paper holding part 31, upstream conveying unit 32, downstream conveying unit 33, holding member 34, and guide member 35. The broken line arrow in FIG. 3 indicates conveyance direction D1 of first drug packaging paper PP1. Packaging paper holding part 31 includes first packaging paper holding part 31a

and second packaging paper holding part 31b. First packaging paper holding part 31a rotatably holds roll M1, which is a package of strip-shaped first drug packaging paper PP1 having been folded in half in advance along the longitudinal direction of first drug packaging paper PP1. Second packaging paper holding part 31b rotatably holds roll M2, which is a package of strip-shaped second drug packaging paper PP2 having been folded in half in advance along the longitudinal direction of second drug packaging paper PP2. The packages of first drug packaging paper PP1 and second drug packaging paper PP2 may be first drug packaging paper PP1 in folds and second drug packaging paper PP2 in folds.

First packaging paper holding part 31a and second packaging paper holding part 31b can be exchanged for each other. That is, first packaging paper holding part 31a can hold roll M2, and second packaging paper holding part 31b can hold roll M1. In this case, a pair of rollers 32b described below nip (i.e., hold the drug packaging paper between the rollers) and convey second drug packaging paper PP2, and another pair of rollers 32d guide first drug packaging paper PP1 without nipping the drug packaging paper.

Upstream conveying unit 32 includes upstream guide member 32a, a pair of rollers 32b, another upstream guide member 32c, the other pair of rollers 32d, and moving member 32e.

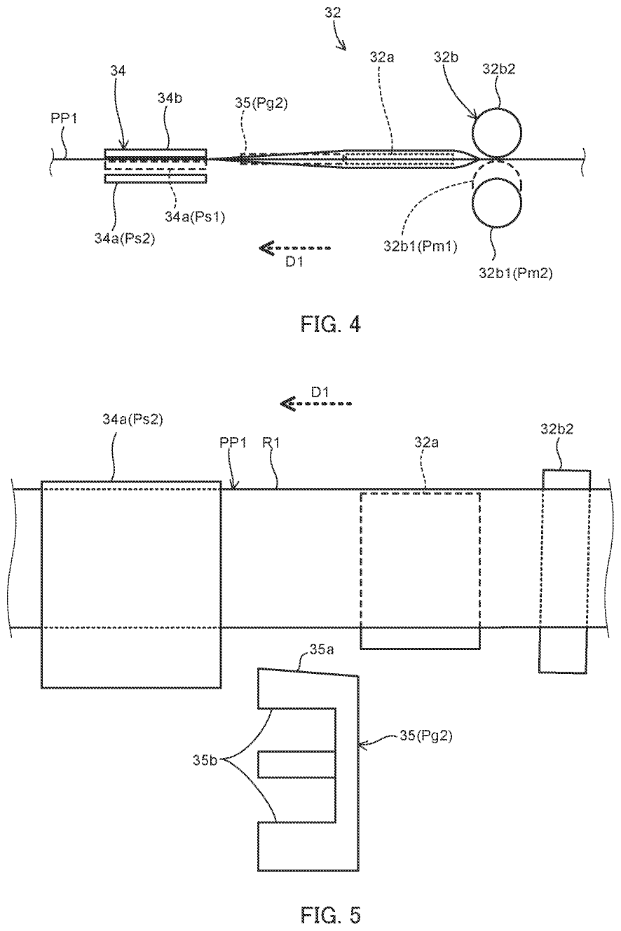

Upstream guide member 32a is configured to guide along conveyance direction D1 first drug packaging paper PP1 fed out from first packaging paper holding part 31a. Upstream guide member 32a is a plate-shaped member sandwiched by first drug packaging paper PP1. As illustrated in FIGS. 4 and 5, which are an enlarged view and a side view of upstream conveying unit 32 and holding member 34 and the peripheries thereof, upstream guide member 32a is disposed in such a way that the side surface thereof coinciding with ridge line R1 of first drug packaging paper PP1 is along conveyance direction D1.

The pair of rollers 32b guide first drug packaging paper PP1 without nipping the drug packaging paper. The pair of rollers 32b are disposed on the upstream side of first drug packaging paper PP1 from upstream guide member 32a. The pair of rollers 32b each have a cylindrical shape. The pair of rollers 32b include driving roller 32b1 and driven roller 32b2.

Driving roller 32b1 is configured to be rotated by a drive device (not illustrated) such as a motor. Driving roller 32b1 is disposed in such a way that the rotational axis thereof is parallel to the plate surface of upstream guide member 32a and orthogonal to conveyance direction D1 of first drug packaging paper PP1. In addition, driving roller 32b1 contacts the side surface of first drug packaging paper PP1, thereby having a function of changing conveyance direction D1 (see FIG. 3).

In addition, driving roller 32b1 is configured to move toward driven roller 32b2 to be located at conveying position Pm1, or to move away from driven roller 32b2 to be located at non-conveying position Pm2. When driving roller 32b1 is located at conveying position Pm1, the pair of rollers 32b can hold first drug packaging paper PP1 or second drug packaging paper PP2 located between the rollers and convey the drug packaging paper toward the downstream side.

Driven roller 32b2 is disposed with the rotational axis thereof inclined. That is, driven roller 32b2 is disposed in such a way that one end part of driven roller 32b2 (on the opened side of first drug packaging paper PP1) is located on the downstream side of first drug packaging paper PP1 from the other end part of driven roller 32b2 (on the ridge line R1 side of first drug packaging paper PP1). In addition, driven roller 32b2 contacts the side surface of first drug packaging paper PP1, thereby having a function of changing conveyance direction D1 (see FIG. 3).

Returning to FIG. 3, the description will be continued. The other upstream guide member 32c is a plate-shaped member sandwiched by the downstream end part of second drug packaging paper PP2 fed out from second packaging paper holding part 31b. The other upstream guide member 32c is disposed in such a way that the plate surface thereof is parallel to the plate surface of upstream guide member 32a, and the side surface thereof coinciding with ridge line R2 of second drug packaging paper PP2 is located on the same plane as the side surface of upstream guide member 32a coinciding with ridge line R1. The plate thickness of the other upstream guide member 32c is approximately the same as the plate thickness of upstream guide member 32a. As will be described below, at the time of replacing first drug packaging paper PP1 with second drug packaging paper PP2, the other upstream guide member 32c guides second drug packaging paper PP2.

The other pair of rollers 32d are disposed on the upstream side of second drug packaging paper PP2 from the other upstream guide member 32c. The other pair of rollers 32d are stationary with the downstream end part of second drug packaging paper PP2 located between the rollers. As will be described below, at the time of replacing first drug packaging paper PP1 with second drug packaging paper PP2, the other pair of rollers 32d nip and convey second drug packaging paper PP2.

The other pair of rollers 32d each have a cylindrical shape. The other pair of rollers 32d include driving roller 32d1 and driven roller 32d2.

Driving roller 32d1 is configured to be rotated by a drive device (not illustrated) such as a motor. Driving roller 32d1 is disposed in such a way that the rotational axis thereof is parallel to the plate surface of the other upstream guide member 32c and orthogonal to conveyance direction D1 of first drug packaging paper PP1.

In addition, driving roller 32d1 is configured to move toward driven roller 32d2 to be located at conveying position Pm1, or to move away from driven roller 32d2 to be located at non-conveying position Pm2. When driving roller 32d1 is located at conveying position Pm1, the other pair of rollers 32d can nip first drug packaging paper PP1 or second drug packaging paper PP2 located between the rollers and convey the drug packaging paper toward the downstream side.

Driven roller 32d2 is disposed with the rotational axis thereof inclined. That is, driven roller 32d2 is disposed in such a way that one end part of driven roller 32d2 (on the opened side of second drug packaging paper PP2) is located on the downstream side of second drug packaging paper PP2 from the other end part of driven roller 32d2 (on the ridge line R2 side of second drug packaging paper PP2). In addition, driven roller 32d2 contacts the side surface of second drug packaging paper PP2, thereby having a function of changing the conveyance direction of second drug packaging paper PP2.

Moving member 32e is configured to be able to move upstream guide member 32a, the pair of rollers 32b, the other upstream guide member 32c, and the other pair of rollers 32d, at the time of replacing first drug packaging paper PP1 with second drug packaging paper PP2. At the time of replacing first drug packaging paper PP1 with second drug packaging paper PP2, the other upstream guide member 32c moves to the position where upstream guide member 32a has been located before upstream guide member 32a is moved, and the other pair of rollers 32d moves to the position where the pair of rollers 32b have been located before the pair of rollers 32b are moved.

Downstream conveying unit 33 is configured to convey first drug packaging paper PP1 guided by upstream conveying unit 32 to printer 15 and sealing device 16. Downstream conveying unit 33 conveys first drug packaging paper PP1 in such a way that first drug packaging paper PP1 receives a drug at drug delivery position Pr.

Downstream conveying unit 33 includes a pair of downstream rollers 33a that nip and convey first drug packaging paper PP1, a plurality of rollers 33b that change conveyance direction D1 of first drug packaging paper PP1, and downstream guide member 33c.

Downstream guide member 33c is a plate-shaped member sandwiched by first drug packaging paper PP1, and configured to guide first drug packaging paper PP1 to drug delivery position Pr. Downstream guide member 33c is disposed in such a way that the plate surface thereof is orthogonal to the horizontal direction. First drug packaging paper PP1 hold, in its inside, downstream guide member 33c with the opened side of the drug packaging paper facing upward (herein, “in its inside” does not necessarily mean that a component is completely in the inside of another component). First drug packaging paper PP1 is opened upward by being guided by downstream guide member 33c, and receives a drug led out from hopper 13b at drug delivery position Pr.

Holding member 34 is disposed between upstream conveying unit 32 and downstream conveying unit 33. Holding member 34 does not hold first drug packaging paper PP1 when conveying part 30 is conveying first drug packaging paper PP1. Holding member 34 holds first drug packaging paper PP1 between the members thereof when first drug packaging paper PP1 is to be replaced with second drug packaging paper PP2, as described below. Holding member 34 is composed of a pair of plate members 34a and 34b. The pair of plate members 34a and 34b are disposed in such a way that the plate surfaces of the members are parallel to the plate surface of upstream guide member 32a. As illustrated in FIG. 4, first plate member 34a and second plate member 34b are configured to be located at holding position Ps1 where the members hold first drug packaging paper PP1 therebeteen or at a non-holding position Ps2 where the members does not hold first drug packaging paper PP1 therebeteen.

Guide member 35 is disposed between holding member 34 and upstream conveying unit 32, as illustrated in FIGS. 3 to 5, and configured to guide second drug packaging paper PP2 when first drug packaging paper PP1 is to be replaced with second drug packaging paper PP2, as described below. Guide member 35 is a plate-shaped member. The plate thickness of guide member 35 is substantially the same as the plate thicknesses of upstream guide member 32a and the other upstream guide member 32c.

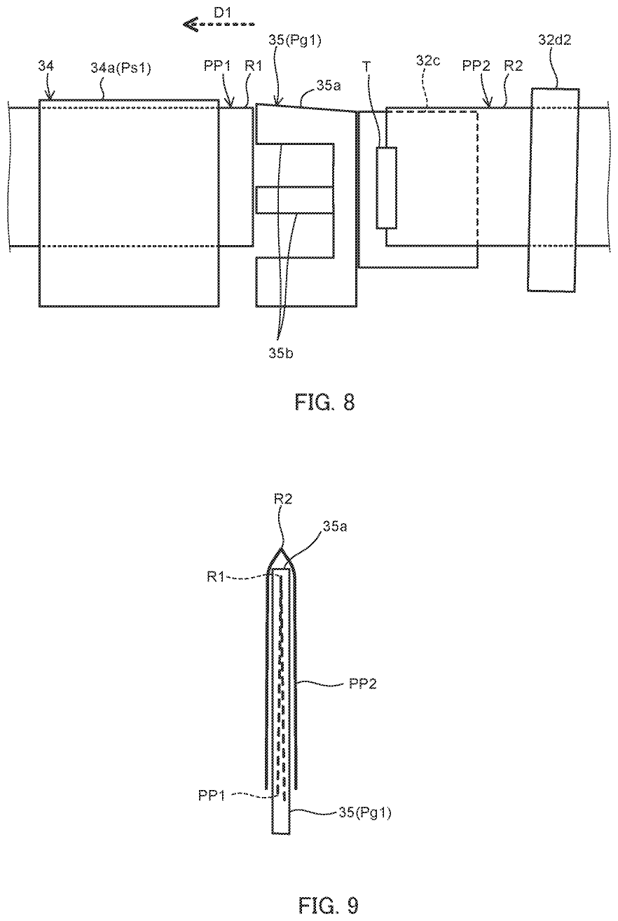

During the conveyance of first drug packaging paper PP1 by upstream conveying unit 32 and downstream conveying unit 33, guide member 35 is located at non-guide position Pg2—a position where the guide member does not contact first drug packaging paper PP1, as illustrated in FIG. 5. As illustrated in FIG. 8 (which will be referred to later), at the time of replacing first drug packaging paper PP1 with second drug packaging paper PP2, guide member 35 is located at guide position Pg1—a position where the guide member can guide second drug packaging paper PP2. That is, guide member 35 is configured to be movable between guide position Pg1 and non-guide position Pg2. Guide member 35 includes inclined part 35a and recessed part 35b.

Inclined part 35a is a side portion of guide member 35, and ridge line R2 of second drug packaging paper PP2 overlaps the side portion at the time of guiding second drug packaging paper PP2 by guide member 35. Inclined part 35a extends in a direction substantially parallel to ridge line R2 of second drug packaging paper PP2 guided by guide member 35. Specifically, inclined part 35a has a shape such that the inclined part is inclined from the opened side toward the ridge line R2 side of second drug packaging paper PP2 as the inclined part approaches the downstream side from the upstream side of second drug packaging paper PP2. Inclined part 35a has a flat shape. Inclined part 35a may have a triangular cross section or an arcuate cross section.

Recessed part 35b is a portion recessed approximately along conveyance direction D1 from the side portion (downstream in conveyance direction D1) of guide member 35.

In the following, the operation of drug supply apparatus 1 when first drug packaging paper PP1 is to be replaced with second drug packaging paper PP2 will be described.

As illustrated FIGS. 3 to 5, when conveying part 30 is conveying first drug packaging paper PP1, driving roller 32b1 is located at the non-conveying position Pm2, first plate member 34a of holding member 34 is located at the non-holding position Ps2, and guide member 35 is located at non-guide position Pg2. In addition, upstream guide member 32a guides first drug packaging paper PP1 while upstream guide member 32a is sandwiched by first drug packaging paper PP1.

For replacing the first drug packaging paper PP1 with second drug packaging paper PP2, the operator inputs into operation part 11 an instruction to replace the packaging paper. Accordingly, the control part stops the operation of drug supply unit 13 and also stops the operation of the pair of downstream rollers 33a.

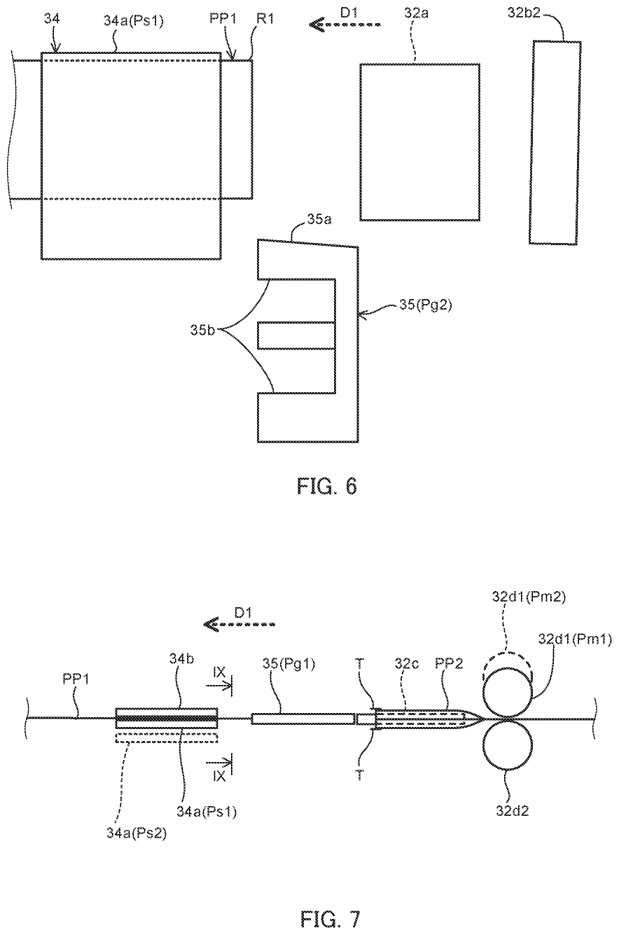

Subsequently, the control part moves first plate member 34a to holding position Ps1. As a result, holding member 34 holds first drug packaging paper PP1 between the members thereof. The operator then cuts first drug packaging paper PP1 on the downstream side from holding member 34, as illustrated in FIG. 6. At this time, the operator cuts first drug packaging paper PP1 in such a way that the downstream end of first drug packaging paper PP1 to be formed by the cutting is located between holding member 34 and guide member 35 located at guide position Pg1. The cutting of first drug packaging paper PP1 may be performed automatically. That is, the following configuration is also possible: conveying part 30 includes a blade for cutting first drug packaging paper PP1, and this blade automatically cuts first drug packaging paper PP1 when the above-described instruction is input to operation part 11.

Further, the control part moves driving roller 32d1 of the other pair of rollers 32d so that the other pair of rollers 32d hold the downstream end part of second drug packaging paper PP2 therebetween. In this state, the control part activates moving member 32e to move upstream guide member 32a, the pair of rollers 32b, the other upstream guide member 32c, and the other pair of rollers 32d. Due to this movement, the other upstream guide member 32c is located at the position where upstream guide member 32a was located, and the other pair of rollers 32d are located at the position where the pair of rollers 32b were located. FIG. 7 illustrates the state at this time.

At this time, the operator attaches adhesive tape T to the downstream end part of second drug packaging paper PP2 so as to protrude from the downstream end of the drug packaging paper as illustrated in FIGS. 7 and 8. Adhesive tapes T are attached to both outer surfaces of second drug packaging paper PP2, which is folded in half. Adhesive tape T may be attached to second drug packaging paper PP2 in advance before moving member 32e is activated, that is, in a state illustrated in FIG. 3.

Subsequently, the operator inputs into operation part 11 information to start conveying second drug packaging paper PP2. The control part accordingly moves guide member 35 to guide position Pg1 as illustrated in FIG. 8. The other pair of rollers 32d hold second drug packaging paper PP2 therebetween. Subsequently, the control part rotates driving roller 32d1 to convey second drug packaging paper PP2.

As illustrated in FIG. 8, driven roller 32d2 is disposed in such a way that one end part of driven roller 32d2 (on the opened side of second drug packaging paper PP2) is located on the downstream side of second drug packaging paper PP2 from the other end part of driven roller 32d2 (on the ridge line R2 side of second drug packaging paper PP2) as described above. Therefore, the other pair of rollers 32d convey second drug packaging paper PP2 in a direction inclined with respect to conveyance direction D1 of first drug packaging paper PP1.

Specifically, the other pair of rollers 32d convey second drug packaging paper PP2 in such a way that the opened side of the downstream end part of second drug packaging paper PP2 approaches the ridge line R1 side of the upstream end part of first drug packaging paper PP1. When second drug packaging paper PP2 is conveyed to guide member 35, second drug packaging paper PP2 is guided by guide member 35. Describing with reference to the state illustrated in FIG. 8, guide member 35 guides second drug packaging paper PP2 in such a way that as second drug packaging paper PP2 moves leftward, the left end of second drug packaging paper PP2 moves upward.

That is, second drug packaging paper PP2 is guided by inclined part 35a of guide member 35 in such a way that as the downstream end part of second drug packaging paper PP2 approaches the upstream end part of first drug packaging paper PP1, the opened side of the downstream end part of second drug packaging paper PP2 approaches the ridge line R1 side of the upstream end part of first drug packaging paper PP1. In other words, the direction in which inclined part 35a guides second drug packaging paper PP2 is approximately the same as the direction in which the other pair of rollers 32d convey second drug packaging paper PP2. Therefore, second drug packaging paper PP2 is smoothly conveyed and guided without being caught by inclined part 35a. In addition, guide member 35 includes recessed part 35b, thereby reducing contact of adhesive tape T with guide member 35.

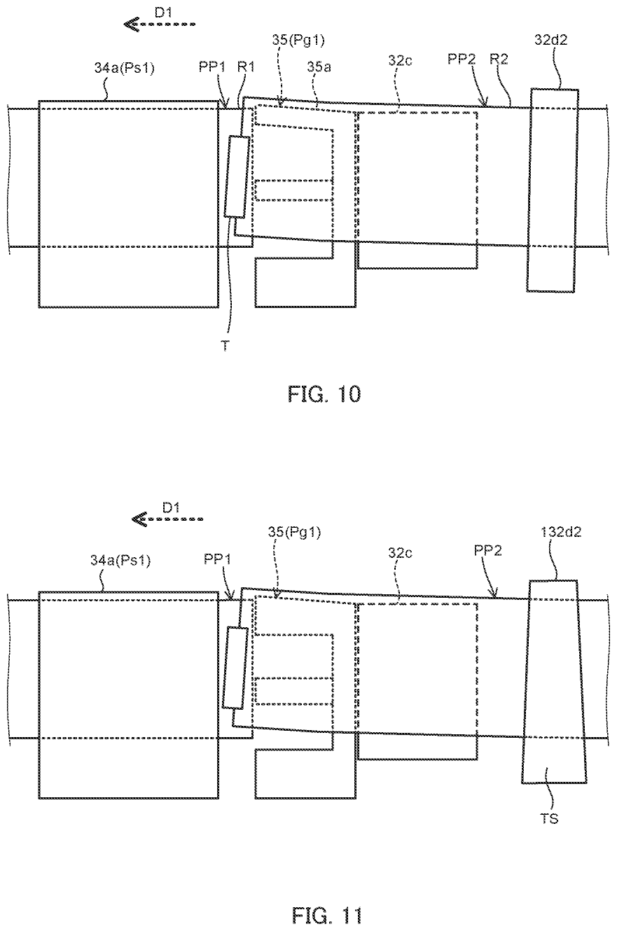

As second drug packaging paper PP2 is conveyed and guided as described above, when second drug packaging paper PP2 is conveyed to the downstream end part of first drug packaging paper PP1, ridge line R2 of second drug packaging paper PP2 is located above ridge line R1 of first drug packaging paper PP1. As illustrated in FIG. 9, a longitudinal cross-sectional view of guide member 35 and a periphery thereof, second drug packaging paper PP2 is wider than the plate thickness of guide member 35. The downstream end part of second drug packaging paper PP2 thus holds, in its inside, the upstream end part of first drug packaging paper PP1, and ridge line R2 of second drug packaging paper PP2 overlaps ridge line R1 of first drug packaging paper PP1, as illustrated in FIG. 10. Second drug packaging paper PP2 is thus smoothly conveyed and guided without the downstream end part of second drug packaging paper PP2 bumping into the upstream end part of first drug packaging paper PP1.

At this time, first drug packaging paper PP1 is held by holding member 34 between the members thereof. Therefore, even when the moving second drug packaging paper PP2 or the moving adhesive tape T comes into contact with first drug packaging paper PP1, first drug packaging paper PP1 can stay at a predetermined position without shifting to the downstream side.

That is, upstream conveying unit 32 conveys second drug packaging paper PP2 in such a way that the opened side of the downstream end part of second drug packaging paper PP2 approaches the ridge line R1 side of the upstream end part of first drug packaging paper PP1. In addition, upstream conveying unit 32 conveys second drug packaging paper PP2 toward first drug packaging paper PP1 in such a way that the downstream end part of second drug packaging paper PP2 holds, in its inside, the upstream end part of first drug packaging paper PP1, and ridge line R2 of second drug packaging paper PP2 overlaps ridge line R1 of first drug packaging paper PP1. Therefore, during the replacement of packaging paper, second drug packaging paper PP2 is smoothly conveyed to overlap first drug packaging paper PP1 while preventing the generation of folds in first drug packaging paper PP1 and second drug packaging paper PP2.

The control part stops the operation of the pair of rollers 32b in response to the downstream end part of second drug packaging paper PP2 overlapping the upstream end part of first drug packaging paper PP1. The control part detects that the downstream end part of second drug packaging paper PP2 overlaps the upstream end part of first drug packaging paper PP1 based on a detection signal from a position sensor (for example, an infrared sensor) detecting the position of second drug packaging paper PP2.

Subsequently, the operator manually attaches adhesive tape T to first drug packaging paper PP1, for example. As a result, second drug packaging paper PP2 is connected to first drug packaging paper PP1. The operator then inputs information indicating that second drug packaging paper PP2 is connected to first drug packaging paper PP1 into the operation part. The control part accordingly positions first plate member 34a at non-holding position Ps2, guide member 35 at non-guide position Pg2, and driving roller 32b1 at non-conveying position Pm2.

Further, when first drug packaging paper PP1 is conveyed by the pair of downstream rollers 33a due to the operation by the control part, second drug packaging paper PP2 connected to first drug packaging paper PP1 is also conveyed. When first drug packaging paper PP1 is consumed, the packaging paper conveyed by conveying part 30 is switched to second drug packaging paper PP2. In addition, the downstream end part of second drug packaging paper PP2 holds, in its inside, the upstream end part of first drug packaging paper PP1; therefore, the upstream end part of second drug packaging paper PP2 is not caught by downstream guide member 33c. Therefore, switching to second drug packaging paper PP2 is performed smoothly.

The present disclosure is not limited to the embodiment described above. Various variations derived from the present embodiment are also included within the scope of the present disclosure, as long as those variations do not depart from the spirit of the present disclosure.

For example, in the pairs of rollers 32b and rollers 32d, not only driven rollers 32b2 and 32d2 but also driving rollers 32b1 and 32d1 may be disposed to be inclined in the same manner as driven rollers 32b2 and 32d2. In place of disposing driven rollers 32b2 and 32d2 so as to be inclined, driving rollers 32b1 and 32d1 may be disposed to be inclined.

As illustrated in FIG. 11, the following configuration is also possible: the circumferential side surface of driven roller 132d2 is tapered surface TS in which the circumferential length on the opened side of second drug packaging paper PP2 is longer than the circumferential length on the ridge line R2 side of second drug packaging paper PP2. Driven roller 132d2 is disposed in such a way that the rotational axis thereof is orthogonal to conveyance direction D1 of first drug packaging paper PP1, and tapered surface TS is in line contact with the side surface of second drug packaging paper PP2. Due to this tapered surface TS, second drug packaging paper PP2 is conveyed in such a way that the opened side of the downstream end part of second drug packaging paper PP2 approaches the ridge line R1 side of the upstream end part of first drug packaging paper PP1. At least one of the circumferential side surfaces of driven roller 32b2 and driving rollers 32b1 and 32d1 may be tapered surface TS.

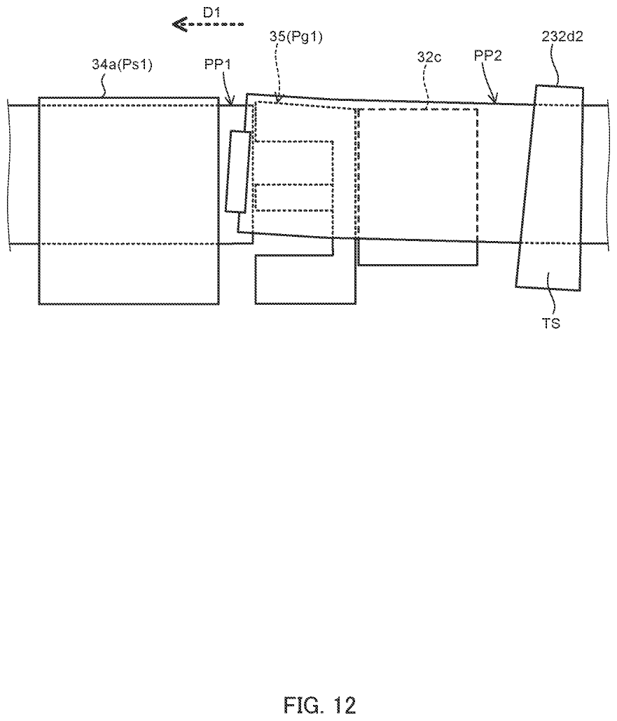

In addition, as illustrated in FIG. 12, driven roller 32d2 including tapered surface TS may be disposed in such a way that one end part of driven roller 32d2 (on the opened side of second drug packaging paper PP2) is located on the downstream side of second drug packaging paper PP2 from the other end part of driven roller 32d2 (on the ridge line R2 side of second drug packaging paper PP2). Regarding the at least one of driven roller 32b2 and driving rollers 32b1 and 32d1 including tapered surface TS, the roller may be disposed in such a way that one end part of the roller (on the opened side of second drug packaging paper PP2) is located on the downstream side of second drug packaging paper PP2 from the other end part of the roller (on the ridge line R2 side of second drug packaging paper PP2).

In addition, conveying part 30 does not need to include second packaging paper holding part 31b, the other upstream guide member 32c, the other pair of rollers 32d, and moving member 32e. In this case, at the time of replacing first drug packaging paper PP1 with second drug packaging paper PP2, the operator cuts first drug packaging paper PP1 as described above while holding member 34 holds first drug packaging paper PP1 between the members thereof, and driving roller 32b1 is located at non-conveying position Pm2.

The operator then removes first drug packaging paper PP1 from first packaging paper holding part 31a and attaches roll M2 of second drug packaging paper PP2 to first packaging paper holding part 31a. The operator further disposes the downstream end part of second drug packaging paper PP2 at upstream guide member 32a, and attaches adhesive tape T to the downstream end part of second drug packaging paper PP2, as described above.

Subsequently, the operator inputs into operation part 11 information to start conveying second drug packaging paper PP2. In response, the control part moves guide member 35 to guide position Pg1 and positions driving roller 32b1 at conveying position Pm1. The control part further rotates driving roller 32b1 to convey second drug packaging paper PP2. As a result, second drug packaging paper PP2 is conveyed and guided as described above and connected to first drug packaging paper PP1.

This application is entitled to and claims the benefit of Japanese Patent Application No. 2021-159495 filed on Sep. 29, 2021, the disclosure of which including the specification, drawings, and abstract is incorporated herein by reference in its entirety.

### INDUSTRIAL APPLICABILITY

The present disclosure is widely available for drug supply apparatuses.

### REFERENCE SIGNS LIST

1 Drug supply apparatus
13 Drug supply unit
30 Conveying part
31 Packaging paper holding part
32 Upstream conveying unit
32a Upstream guide member
32b Pair of rollers
32c Another upstream guide member
32d Another pair of rollers
32e Moving member
33 Downstream conveying unit
33c Downstream guide member
35 Guide member
35a Inclined part
PP1 First drug packaging paper
PP2 Second drug packaging paper
Pr Drug delivery position
R1 Ridge line of first drug packaging paper
R2 Ridge line of second drug packaging paper
TS Tapered surface

1. A drug supply apparatus, comprising:
a drug supply unit configured to supply a drug to a drug delivery position;
a downstream conveying unit configured to convey a first drug packaging paper that is strip shaped and folded in half in advance along a longitudinal direction of the first drug packaging paper, wherein the first drug packaging paper is configured to receive a drug at the drug delivery position; and
an upstream conveying unit configured to convey a second drug packaging paper that is strip shaped and folded in half in advance along a longitudinal direction of the second drug packaging paper, wherein
the upstream conveying unit conveys the second drug packaging paper toward the first drug packaging paper in such a way that a downstream end part of the second drug packaging paper holds, in an inside of the downstream end part, an upstream end part of the first drug packaging paper, and a ridge line of the second drug packaging paper overlaps a ridge line of the first drug packaging paper.

2. The drug supply apparatus according to claim 1, wherein
the upstream conveying unit conveys the second drug packaging paper in such a way that an opened side of the downstream end part of the second drug packaging paper approaches a ridge line side of the upstream end part of the first drug packaging paper.

3. The drug supply apparatus according to claim 1, wherein
the upstream conveying unit includes a pair of rollers configured to nip and convey the second drug packaging paper.

4. The drug supply apparatus according to claim 3, wherein
at least one roller of the pair of rollers is disposed in such a way that one end part of the at least one roller is located on a downstream side of the second drug packaging paper from another end part of the at least one roller, the one end part being on an opened side of the second drug packaging paper, the other end part being on a ridge line side of the second drug packaging paper.

5. The drug supply apparatus according to claim 3, wherein
a circumferential side surface of at least one roller of the pair of rollers is a tapered surface with a circumferential length on an opened side of the second drug packaging paper longer than a circumferential length on a ridge line side of the second drug packaging paper.

6. The drug supply apparatus according to claim 1, further comprising:
a guide member configured to guide the second drug packaging paper while the guide member is sandwiched by the second drug packaging paper, wherein
the guide member has a shape allowing the guide member to guide the second drug packaging paper in such a way that as the downstream end part of the second drug packaging paper approaches the upstream end part of the first drug packaging paper, an opened side of the downstream end part of the second drug packaging paper approaches a ridge line side of the upstream end part of the first drug packaging paper.

7. The drug supply apparatus according to claim 6, wherein
the guide member includes an inclined part extending in a direction substantially parallel to the ridge line of the second drug packaging paper guided by the guide member.

8. The drug supply apparatus according to claim 6, wherein
the guide member is plate shaped.
